(19) United States
(12) Patent Application Publication
(10) Pub. No.: US 2024/0346940 A1
(43) Pub. Date: Oct. 17, 2024

(54) PERFORMANCE MODE FOR A HYBRID VEHICLE - SYNCHRONIZED PROPULSION

(71) Applicants: Hyundai Motor Company, Seoul (KR); Kia Corporation, Seoul (KR)

(72) Inventors: Ernestine Fu, Somerville, MA (US); John Suh, Palo Alto, CA (US); Alec Taraborrelli, Superior Township, MI (US)

(21) Appl. No.: 18/133,745

(22) Filed: Apr. 12, 2023

(51) Int. Cl. G08G 5/00; B60F 5/02; B64U 10/70

(52) U.S. Cl. CPC G08G 5/006; B60F 5/02; B64U 10/70; G08G 5/0069

(57) ABSTRACT

A hybrid vehicle is provided. The hybrid vehicle may comprise a chassis, a plurality of leg-wheel components coupled to the chassis, wherein the plurality of leg-wheel components may be configured to be collectively operable to provide wheeled locomotion and walking locomotion, an airborne propulsion system, coupled to the chassis, and a processor configured to cause the plurality of leg-wheel components and the airborne propulsion system to propel a hybrid vehicle. The airborne propulsion system may be configured to operate synchronously with at least one of the wheeled locomotion and walking locomotion.

### BACKGROUND

### Technical Field

Embodiments of the present disclosure relate to a hybrid vehicle configured to provide synchronized lift in conjunction with wheeled locomotion and walking locomotion.

### Background

New motor vehicles that are capable of wheeled and walking motion may be capable of omnidirectional movement (e.g., being configured to walk in a walking mode). The ability to travel using both wheeled and walking locomotion allows these vehicles, also referred to as “hybrid” vehicles, to navigate over rugged and undrivable terrain, opening up opportunities for exploration, search and rescue, military operations, etc. However, even while being given access to previously inaccessible terrain, hybrid vehicles may still encounter impassable obstructions or terrain, requiring additional support or functionality to overcome such obstacles.

### SUMMARY

Embodiments described herein provide enhanced performance mode for a vehicle capable of locomotion using both walking motion and rolling traction, also referred to herein as a “hybrid vehicle.” In accordance with the described embodiments, the hybrid vehicle also includes a third propulsion system, such as, e.g., one or more rotors, configured to provide lift to the hybrid vehicle to assist in vehicular mobility during an enhanced performance mode. During the enhanced performance mode, the propulsion of the third propulsion system may be synchronized with at least one of the wheeled and/or walking locomotion systems, to improve the mobility of the hybrid vehicle.

During wheeled or walking locomotion, the hybrid vehicle described herein may encounter an obstacle that might not otherwise be traversable using walking and/or wheeled locomotion. For example, when in wheeled locomotion, the hybrid vehicle may encounter a wall, boulder, and/or other obstacle that is not traversable using wheeled and/or walking locomotion, in particular if there is no way to circumvent and/or otherwise go around the obstacle (e.g., the road has a cliffside drop off). Similarly, during walking locomotion, the hybrid vehicle may encounter a particularly steep or large obstruction that is blocking its path of navigation. The described embodiments provide an enhanced performance mode for utilizing an additional propulsion system in synchronization with the wheeled and/or walking locomotion to overcome these types of extreme obstructions.

In some exemplary embodiments, the third propulsion system described herein may be used in cooperation with a springing action of one or more leg components to leap over an obstacle that could not ordinarily be traversed by the hybrid vehicle using just its leg components and/or wheel components. For example, a rotor system may not be capable of providing enough lift to maintain the hybrid vehicle in a stable aerial position in isolation, but may be configured to provide sufficient thrust to reduce the gravitational force on the hybrid vehicle body so that additional performance can be obtained over an absence of the third propulsion system's capability, thereby allowing for the traversal of otherwise non-traversable terrain.

According to an object of the present disclosure, a hybrid vehicle is provided. The hybrid vehicle may comprise a chassis, a plurality of leg-wheel components coupled to the chassis, wherein the plurality of leg-wheel components may be configured to be collectively operable to provide wheeled locomotion and walking locomotion, an airborne propulsion system, coupled to the chassis, and a processor configured to cause the plurality of leg-wheel components and the airborne propulsion system to propel a hybrid vehicle. The airborne propulsion system may be configured to operate synchronously with at least one of the wheeled locomotion and walking locomotion, for example to assist in overcoming gravitational forces placed on the hybrid vehicle.

According to an exemplary embodiment, the processor may be further configured to automatically propel the hybrid vehicle along a path using one or more of: one or more of the plurality of leg-wheel components; and the airborne propulsion system.

According to an exemplary embodiment, the hybrid vehicle may further comprise one or more sensors configured to detect one or more obstacles within the path of the hybrid vehicle. The processor may be further configured to determine whether the one or more obstacles are traversable using walking or wheeled locomotion, and, when the one or more obstacles are not traversable using walking or wheeled locomotion, cause the airborne propulsion system to propel the hybrid vehicle to overcome the one or more obstacles.

According to an exemplary embodiment, the airborne propulsion system may be permanently affixed to the chassis.

According to an exemplary embodiment, the airborne propulsion system may be detachably coupled to the chassis.

According to an exemplary embodiment, the airborne propulsion system may comprise an unmanned aerial vehicle (UAV).

According to an exemplary embodiment, the airborne propulsion system may comprise at least one rotor system.

According to an exemplary embodiment, the airborne propulsion system may be configured to reduce a downforce on the hybrid vehicle for synchronous operation during wheeled locomotion.

According to an exemplary embodiment, the airborne propulsion system may be configured to perform synchronous operation during a springing action of one or more of the plurality of leg-wheel components during the walking locomotion.

According to an exemplary embodiment, the hybrid vehicle may comprise one or more sensors configured to perform one or more of: terrain surveillance; and terrain mapping.

According to an exemplary embodiment, the one or more sensors may comprise one or more cameras.

According to an exemplary embodiment, at least one of the one or more sensors may be coupled to the airborne propulsion system

According to an object of the present disclosure, a system for controlling a hybrid vehicle is provided The system may comprise a hybrid vehicle. The hybrid vehicle may comprise a chassis, a plurality of leg-wheel components coupled to the chassis, wherein the plurality of leg-wheel components are configured to be collectively operable to provide wheeled locomotion and walking locomotion, and an airborne propulsion system, coupled to the chassis. The system may comprise a computing device, comprising a processor and a memory, configured to store programming instructions that, when executed by the processor, cause the processor to cause the airborne propulsion system to operate synchronously with at least one of the wheeled locomotion and walking locomotion, for example, to assist in overcoming gravitational forces placed on the hybrid vehicle.

According to an exemplary embodiment, the airborne propulsion system may be permanently affixed to the chassis.

According to an exemplary embodiment, the airborne propulsion system may be detachably coupled to the chassis.

According to an exemplary embodiment, the airborne propulsion system may comprise an unmanned aerial vehicle (UAV).

According to an exemplary embodiment, the airborne propulsion system may comprise at least one rotor system.

According to an exemplary embodiment, the airborne propulsion system may be configured to reduce a downforce on the hybrid vehicle for synchronous operation during wheeled locomotion, and the programming instructions, when executed by the processor, may cause the processor to cause the airborne propulsion system to reduce the downforce on the hybrid vehicle for synchronous operation during wheeled locomotion.

According to an exemplary embodiment, the airborne propulsion system may be configured to perform synchronous operation during a springing action of one or more of the plurality of leg-wheel components during the walking locomotion, and the programming instructions, when executed by the processor, may cause the processor to cause the airborne propulsion system to perform synchronous operation during the springing action of the one or more of the plurality of leg-wheel components during the walking locomotion.

According to an exemplary embodiment, the system may further comprise one or more sensors configured to perform one or more of: terrain surveillance; and terrain mapping.

According to an exemplary embodiment, the one or more sensors may comprise one or more cameras.

According to an exemplary embodiment, at least one of the one or more sensors may be coupled to the airborne propulsion system

### BRIEF DESCRIPTION OF THE DRAWINGS

The accompanying drawings, which are incorporated in and form a part of the Detailed Description, illustrate various embodiments of the subject matter and, together with the Detailed Description, serve to explain principles of the subject matter discussed below. Unless specifically noted, the drawings referred to in this Brief Description of Drawings should be understood as not being drawn to scale. Herein, like items are labeled with like item numbers.

FIG. 1 is a diagram illustrating an example uncrewed hybrid vehicle comprising an aerial drone, according to an exemplary embodiment.

FIG. 2 is a diagram illustrating an example hybrid vehicle capable of carrying passengers comprising an aerial drone, according to an exemplary embodiment.

FIG. 3 is a diagram illustrating an example unmanned aerial vehicle (UAV), according to an exemplary embodiment.

FIGS. 4A and 4B are diagrams illustrating a leg-wheel component in retracted and extended positions, according to some exemplary embodiments.

FIG. 4C is a diagram illustrating the low range of motion suspension stage and the high range of motion suspension stage, according to an exemplary embodiment.

FIG. 5 is an illustration of a hybrid vehicle with an attached aerial drone performing a mapping operation within a mine, according to an exemplary embodiment.

FIGS. 6A through 6C are illustrations of a hybrid vehicle with a coupled UAV navigating using propulsion of leg-wheel components and the UAV to overcome an obstacle, according to an exemplary embodiment.

FIG. 7 is an illustration of a hybrid vehicle with a coupled UAV reducing downforce using propulsion of the UAV during navigation, according to an exemplary embodiment.

FIG. 8 is a diagram illustrating a use case of a combination two vehicle system including UAV surveying terrain and communicating information about the terrain to a hybrid vehicle, in accordance with an exemplary embodiment.

FIG. 9 is a diagram illustrating a use case of a combination two vehicle system including a hybrid vehicle having a cargo pod and a UAV for transporting the cargo pod, in accordance with an exemplary embodiment.

FIG. 10 illustrates example elements of a computing device, according to an exemplary embodiment of the present disclosure.

FIG. 11 illustrates an example architecture of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum) As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Detailed Description, numerous specific details are set forth in order to provide a thorough understanding of embodiments of the present subject matter. However, embodiments may be practiced without these specific details In other instances, well known methods, procedures, and components have not been described in detail as not to unnecessarily obscure aspects of the described embodiments.

Discussion begins with a description of a walking vehicle including an unmanned aerial vehicle (UAV), in accordance with exemplary embodiments Examples of navigation of a walking vehicle comprising a rotor system are then described.

Embodiments described herein provide an enhanced performance mode for a vehicle capable of locomotion using both walking motion and rolling traction, also referred to herein as a “hybrid vehicle” In accordance with the described exemplary embodiments, the hybrid vehicle may also comprise a third propulsion system, such as, e.g., one or more rotors or rotor systems, configured for providing lift to the hybrid vehicle to assist in vehicular mobility during the enhanced performance mode. During the enhanced performance mode, the propulsion of the third propulsion system may be synchronized with at least one of the wheeled and/or walking locomotion systems, to improve the mobility of the hybrid vehicle.

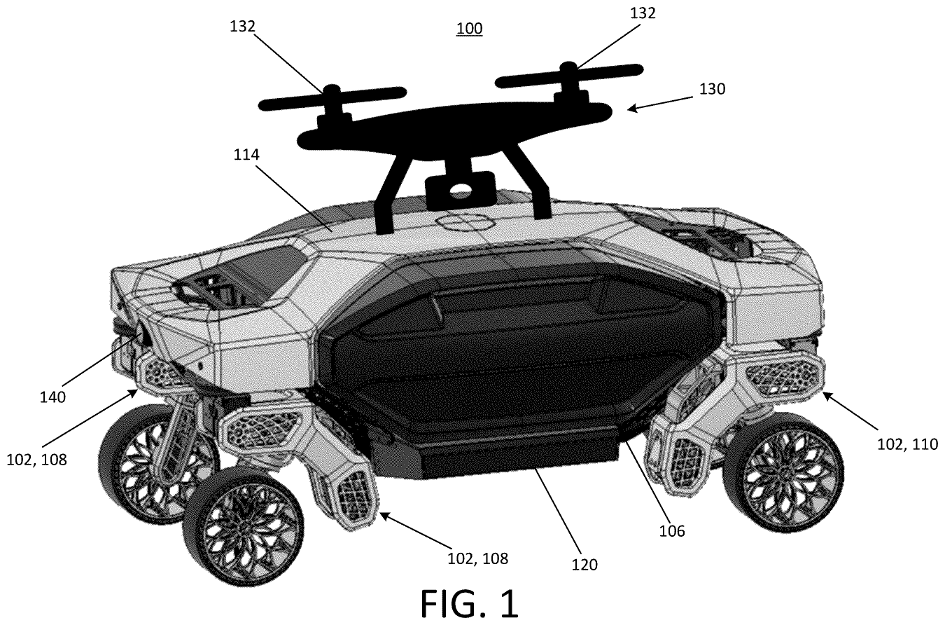

Referring now to FIG. 1, a diagram of an uncrewed hybrid vehicle 100 is illustratively depicted, in accordance with an exemplary embodiment of the present disclosure.

According to an exemplary embodiment, the uncrewed hybrid vehicle 100 may comprise an unmanned aerial vehicle (UAV) 130, also referred to herein as an “aerial drone,” according to some exemplary embodiments. The UAV 130 may be configured to be removably coupled to the hybrid vehicle 100 for conveyance by the hybrid vehicle 100 from a first location to a second location, and for providing additional propulsion to the hybrid vehicle 100 during an enhanced performance mode.

The Hybrid vehicle 100 and the UAV 130 may be configured to leverage the efficiency of land-based travel to a launching point. The UAV 130 may be configured to release from the hybrid vehicle 100 and perform one or more air-based operations. It should be appreciated that the hybrid vehicle 100 may comprise and/or be configured to transport one or more UAVs 130.

In accordance with various embodiments, the UAV 130 may be configured to provide a third propulsion system to the hybrid vehicle 100 (with wheeled locomotion and walking locomotion being the other two propulsion systems) for providing lift to the hybrid 100 vehicle to assist in vehicular mobility during an enhanced performance mode. According to an exemplary embodiment, during the enhanced performance mode, the propulsion of UAV 130 may be synchronized with at least one of the wheeled and/or walking locomotion systems, to improve the mobility of the hybrid vehicle 100 to overcome obstacles or untraversable terrain. According to an exemplary embodiment, the UAV 130 may be a permanent structure of the hybrid vehicle 100, e.g., one or more rotor systems 132 affixed to the top of the hybrid vehicle 100. According to an exemplary embodiment, as illustrated, the third propulsion system may be a separate detachable unit, such as an unmanned aerial vehicle (UAV) 130 or a drone, such as a quadcopter.

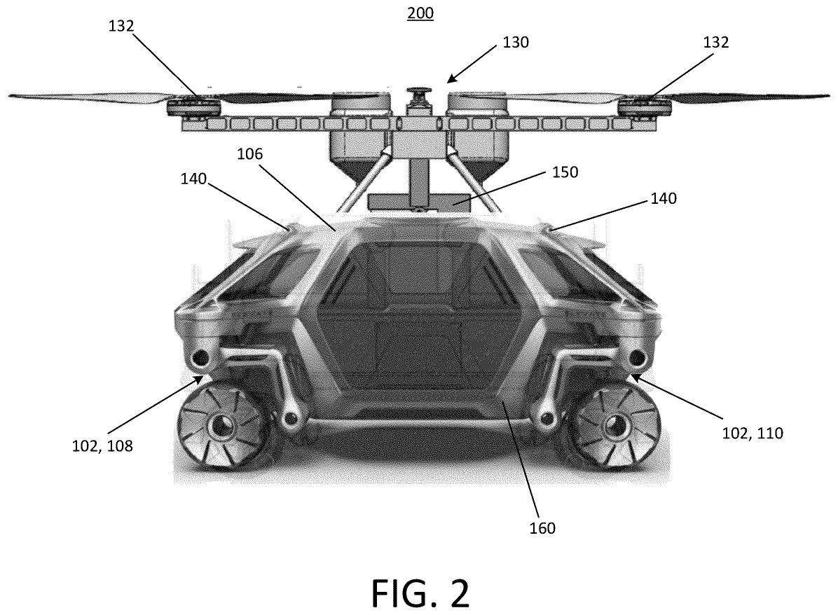

According to an exemplary embodiment, the hybrid vehicle 100 may be configured for autonomous navigation, such that the hybrid vehicle 100 may be configured to navigate without human control According to an exemplary embodiment, the control of the UAV 130 may also be autonomous. According to an exemplary embodiment, the hybrid vehicle 100 and the UAV 130 may be configured to be controlled remotely by a human operator. It should be appreciated that any combination of autonomous and remote control may be used to control the hybrid vehicle 100 and/or the UAV 130. For example, the hybrid vehicle 100 may be configured to operate autonomously until a destination is reached and/or an obstacle is encountered, at which point a human operator may take control. In some exemplary embodiments, the hybrid vehicle 100 and the UAV 130 may comprise one or more cameras 140 configured to capture one or more images in order for a position of the hybrid vehicle 100 and/or the UAV 130 to be displayed to a human operator. While the hybrid vehicle 100 may be described herein as an uncrewed vehicle, it should be appreciated that, in some exemplary embodiments, the hybrid vehicle 100 may be configured to carry one or more human passengers (e.g., hybrid vehicle 200 of FIG. 2).

According to an exemplary embodiment, the hybrid vehicle 100 may be configured to provide the movement capability of rolling motion and walking motion, referred to herein as leg-wheel locomotion, that may be used in remotely controlled or autonomous vehicles. Such articulation in movement enables exploration of extreme off-road terrains using walking gaits, as well as travel across roads using efficient rolling modes. For instance, the hybrid vehicle 100 may be configured to scale rough rocks that would otherwise be untraversable using a conventional vehicle. Simultaneously, the hybrid vehicle 100 may be configured to traverse both paved and unpaved roads using driven wheel locomotion. This dual-domain is enabled by using leg-wheel locomotion. For example, the hybrid vehicle 100 may be configured to perform wheeled locomotion over flat terrain and may be configured to perform walking locomotion over rugged and extreme terrain.

The hybrid vehicle 100 may comprise four leg-wheel components 102, each configured to perform with at least two degrees of freedom. According to an exemplary embodiment, the leg-wheel components 102 may be configured to perform with at least six degrees of freedom. According to an exemplary embodiment, the leg-wheel components 102 may be configured to be controlled collectively to provide rolling and walking locomotion. According to an exemplary embodiment, each leg-wheel component 102 may be configured to perform different movement or positioning during operation. For example, while using wheeled locomotion on an upward slope, in order to maintain a body 114 and chassis 106 of the hybrid vehicle 100 level with flat ground, front leg-wheel components 108 may be configured to be retracted, and rear leg-wheel components 110 may be configured to be extended. In another example, while using walking locomotion to traverse rough terrain, each leg-wheel component 102, or opposite pairs of leg-wheel components 102 (e g., front left and rear right), may be configured to move differently from the other leg-wheel components 102.

During wheeled or walking locomotion, the hybrid vehicle 100 may encounter an obstacle that might not otherwise be traversable using walking and/or wheeled locomotion. For example, when in wheeled locomotion, the hybrid vehicle 100 may encounter a wall, boulder, and/or other obstacle that is not traversable using a wheeled and/or walking mode, in particular if there is no way to circumvent or otherwise go around the obstacle (e.g., a road has a cliffside drop off, etc.). Similarly, during walking locomotion, the hybrid vehicle 100 may encounter a particularly steep or large obstruction that is blocking its path of navigation. The described exemplary embodiments provide an enhanced performance mode for utilizing a propulsion system of the UAV 130, in synchronization with the wheeled and/or walking locomotion, to overcome these types of extreme obstructions.

According to an exemplary embodiment, the UAV 130 may comprise one or more rotor systems 132. According to an exemplary embodiment, the UAV 130 may be configured to be coupled to the hybrid vehicle 100, e.g., on the top of the hybrid vehicle 100. According to an exemplary embodiment, the UAV 130 may be configured to provide lift to the otherwise rolling or walking hybrid vehicle 100. Utilizing the one or more rotor systems 132 of the UAV 130 in synchronization with wheeled and/or walking locomotion may provide a temporary performance and mobility advantage to the hybrid vehicle 100. For example, the one or more rotor systems 132 may be capable of lifting and/or configured to lift the hybrid vehicle 100 off the ground to enable relocation of the hybrid vehicle 100 to a position beyond an obstacle. While the UAV 130 may be capable of carrying the hybrid vehicle 100 a greater distance than needed to overcome obstacles, the power consumption needs of the UAV 130 in lifting hybrid vehicle 100 may be greater than the power consumption needs of wheeled and/or walking locomotion. Therefore, the UAV 130 may be configured to provide an enhanced performance mode in instances of need, so as to prolong battery life and limit fuel consumption.

According to an exemplary embodiment, the propulsion system of the UAV 130 may be configured to operate with at least one of the wheeled locomotion and walking locomotion to assist in overcoming gravitational forces placed on the hybrid vehicle 100. According to an exemplary embodiment, the propulsion system of the UAV 130 may be configured to operate at the same time as (e.g., synchronously with) at least one of the wheeled locomotion and walking locomotion to assist in overcoming gravitational forces placed on the hybrid vehicle 100. It is noted, however, that, in some exemplary embodiments, the propulsion system of the UAV 130 may be used interchangeably with at least one of the wheeled locomotion and walking locomotion as needed to assist in overcoming the gravitational forces placed on the hybrid vehicle 100.

For example, the propulsion system of the UAV 130 may be configured to apply an upward thrust on the hybrid vehicle 100, decreasing a downward force of the hybrid vehicle 100 upon a surface, while the hybrid vehicle 100 uses wheeled or walking locomotion. This upward thrust, while using the wheeled or walking locomotion, may decrease the effort needed by the hybrid vehicle 100 to traverse terrain while using the wheeled or walking locomotion.

According to an exemplary embodiment, the propulsion system of the UAV 130 may be configured to be used in cooperation with a springing action of one or more leg components 202 (of the one or more leg-wheel components 102) to leap over an obstacle that could not ordinarily be traversed by the hybrid vehicle 100 using just its leg components 202 or wheel components 204. For example, the rotor system 132 of the UAV 130 may not be capable of providing enough lift to maintain the hybrid vehicle 100 in a stable aerial position in isolation, but may be configured to provide sufficient thrust to reduce the gravitational force on the hybrid vehicle 100 so that additional performance may be obtained over an absence of the propulsion system's capabilities of the UAV 130, thereby allowing for the traversal of otherwise non-traversable terrain. According to an exemplary embodiment, the one or more rotor systems 132 of the UAV 130 may be capable of providing enough lift to maintain the hybrid vehicle 100 in a stable aerial position in isolation.

According to an exemplary embodiment, the hybrid vehicle 100 may comprise at least one cargo pod 120 configured to store cargo. According to an exemplary embodiment, the hybrid vehicle 100 may be configured to receive and transport cargo pod 120. According to an exemplary embodiment, the UAV 130 may be configured to receive and transport cargo pod 120, subject to weight and size restrictions.

Referring now to FIG. 2, a diagram of a hybrid vehicle 200 comprising an unmanned aerial vehicle (UAV) 130 is illustratively depicted, in accordance with an exemplary embodiment of the present disclosure.

According to an exemplary embodiment, the UAV 130 may be configured to removably couple to the hybrid vehicle 200 for conveyance by the hybrid vehicle 200 from a first location to a second location. According to an exemplary embodiment, the UAV 130 may be configured to provide additional propulsion to the hybrid vehicle 200 during an enhanced performance mode. The hybrid vehicle 200 and the UAV 130 may leverage the efficiency of land-based travel to a launching point, where the UAV 130 may be configured to release from the hybrid vehicle 200 and perform one or more air-based operations. It should be appreciated that the hybrid vehicle 200 may comprise and/or transport one or more UAVs 130. It should be appreciated that the hybrid vehicle 200 and the UAV 130 may be configured to operate in a similar manner as hybrid vehicle 100 and UAV 130 of FIG. 1, with the exception that hybrid vehicle 200 is configured to carry human passengers According to an exemplary embodiment, the hybrid vehicle 200 may comprise a passenger compartment 160 configured to receive one or more human passengers.

In accordance with various embodiments, the UAV 130 may be configured to operate to provide a third propulsion system to the hybrid vehicle 200 (with wheeled locomotion and walking locomotion being the other two propulsion systems) for providing lift to the hybrid vehicle 200 to assist in vehicular mobility during an enhanced performance mode. During the enhanced performance mode, the propulsion of the UAV 130 may be synchronized with at least one of the wheeled and/or walking locomotion systems, to improve mobility of the hybrid vehicle 200 to overcome obstacles or untraversable terrain. It should be appreciated that, in some exemplary embodiments, the UAV 130 may be a permanent structure of the hybrid vehicle 200, e.g., one or more rotor systems affixed to the top of the hybrid vehicle 200. According to an exemplary embodiment, as illustrated, the third propulsion system may be a separate detachable unit, such as the UAV 130 or a drone, such as a quadcopter.

According to an exemplary embodiment, the hybrid vehicle 200 may be configured to perform autonomous navigation, such that the hybrid vehicle 200 may be configured to navigate without human control. According to an exemplary embodiment, the control of the UAV 130 may also be autonomous. According to an exemplary embodiment, the hybrid vehicle 100 and/or the UAV 130 may be configured to be controlled by a human operator, either onboard or remote to the hybrid vehicle 200. It should be appreciated that any combination of autonomous and remote control may be used to control the hybrid vehicle 200 and/or the UAV 130 For example, the hybrid vehicle 200 may be configured to operate autonomously until a destination is reached and/or an obstacle is encountered, at which point a human operator may take control. According to an exemplary embodiment, the hybrid vehicle 200 and/or the UAV 130 may comprise one or more cameras 140 configured to capture one or more images in order for a position of the hybrid vehicle 200 and/or the UAV 130 to be displayed to a human operator.

According to an exemplary embodiment, the hybrid vehicle 200 may be configured to provide a movement capability of rolling motion and/or walking motion, referred to herein as leg-wheel locomotion, that may be used in remotely controlled or autonomous vehicles. Such articulation in movement may enable exploration of extreme off-road terrains using walking gaits, as well as travel across roads using efficient rolling modes. For instance, the hybrid vehicle 200 may be configured to scale rough rocks that would otherwise be untraversable using a conventional vehicle According to an exemplary embodiment, the hybrid vehicle 200 may be configured to traverse both paved and unpaved roads using driven wheel locomotion. This dual-domain is enabled by using leg-wheel locomotion. For example, the hybrid vehicle 200 may be configured to perform wheeled locomotion over flat terrain and may be configured to perform walking locomotion over rugged and extreme terrain

The hybrid vehicle 200 may comprise four leg-wheel components 102, each configured to perform with at least two degrees of freedom, and may be configured to operate as leg-wheel components 102 described above in accordance with FIG. 1. According to an exemplary embodiment, the leg-wheel components 102 may be configured to perform with at least six degrees of freedom.

During wheeled or walking locomotion, the hybrid vehicle 200 may encounter an obstacle that might not otherwise be traversable using walking and/or wheeled locomotion For example, when in wheeled locomotion, the hybrid vehicle 200 may encounter a wall, boulder, and/or other obstacle that is not traversable using a wheeled and/or walking mode, in particular if there is no way to circumvent or otherwise go around the obstacle (e.g., the road has a cliffside drop off, etc.). Similarly, during walking locomotion, the hybrid vehicle 200 may encounter a particularly steep or large obstruction that is blocking its path of navigation. The described exemplary embodiments provide an enhanced performance mode for utilizing a propulsion system of the UAV 230 in synchronization with the wheeled and/or walking locomotion to overcome these types of extreme obstructions

According to an exemplary embodiment, the UAV 130 may comprise one or more rotor systems 132. According to an exemplary embodiment, the UAV 130 may be configured to be coupled to the hybrid vehicle 200, e.g., at a connection mechanism 150 on the top of the hybrid vehicle 200. According to an exemplary embodiment, the UAV 130 may be configured to provide lift to the otherwise rolling and/or walking hybrid vehicle 200. Utilizing the one or more rotor systems 132 of the UAV 130 in synchronization with the wheeled and/or walking locomotion may provide a temporary performance and mobility advantage to the hybrid vehicle 200. For example, the one or more rotor systems 132 may be capable of lifting the hybrid vehicle 200 off the ground to enable relocation of the hybrid vehicle 200 to a position beyond an obstacle While the UAV 130 may be capable of carrying the hybrid vehicle 200 a greater distance than needed to overcome obstacles, the power consumption needs of the UAV 130 in lifting the hybrid vehicle 200 may be greater than the power consumption needs of wheeled and/or walking locomotion. Therefore, the UAV 130 may be configured to provide an enhanced performance mode in instances of need, so as to prolong battery life and limit fuel consumption

According to an exemplary embodiment, the hybrid vehicle 200 may comprise one or more sensors 170. The one or more sensors 170 may be configured to detect one or more obstacles that might not otherwise be traversable using walking and/or wheeled locomotion. According to an exemplary embodiment, the one or more sensors 170 may be configured to collect one or more points of data pertaining to an environment of the hybrid vehicle 200. The one or more sensors 170 may be in electronic communication with a computing device (e.g., computing device 1000) of the hybrid vehicle 200 and may be configured to send the one or more data points to the computing device. The computing device (via, e.g., one or more processors) may be configured to interpret the one or more data points in order to determine whether the one or more obstacles are within a path of the hybrid vehicle 200.

According to an exemplary embodiment, when the computing device determines that one or more obstacles are present within the path of the hybrid vehicle 200, the computing device may be configured to automatically engage the third propulsion system (e.g., the UAV 130) when needed to enable the hybrid vehicle 200 to overcome or otherwise pass the one or more obstacles.

According to an exemplary embodiment, the propulsion system of the UAV 130 may be configured to be used in cooperation with a springing action of one or more leg components 202 (of the one or more leg-wheel components 102) to leap over an obstacle that could not ordinarily be traversed by the hybrid vehicle 200 using just its leg components 202 or wheel components 204. For example, the rotor system 132 of the UAV 130 may not be capable of providing enough lift to maintain the hybrid vehicle 200 in a stable aerial position in isolation, but may be configured to provide sufficient thrust to reduce the gravitational force on the hybrid vehicle 200 so that additional performance may be obtained over an absence of the propulsion system's capabilities of the UAV 130, thereby allowing for the traversal of otherwise non-traversable terrain. According to an exemplary embodiment, the one or more rotor systems 132 of the UAV 130 may be capable of providing enough lift to maintain the hybrid vehicle 200 in a stable aerial position in isolation.

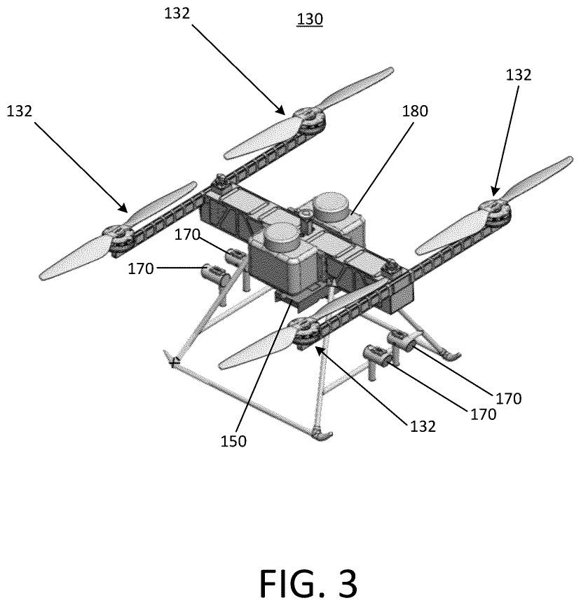

Referring now to FIG. 3, a diagram of an example UAV 130 is illustratively depicted, in accordance with an exemplary embodiment of the present disclosure.

According to an exemplary embodiment, the UAV 130 may comprise one or more rotor systems 132. According to an exemplary embodiment, the UAV 130 may be configured to be coupled to a hybrid vehicle (e.g., hybrid vehicle 100 of FIG. 1 and hybrid vehicle 200 of FIG. 2) on top of the hybrid vehicle. The UAV 130 may comprise one or more connection mechanisms 150 configured to couple the UAV 130 to the hybrid vehicle

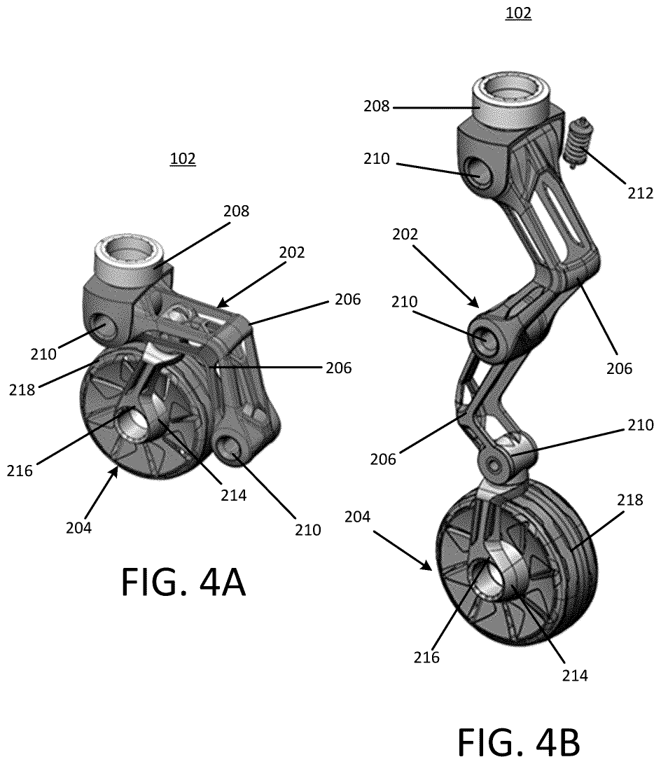

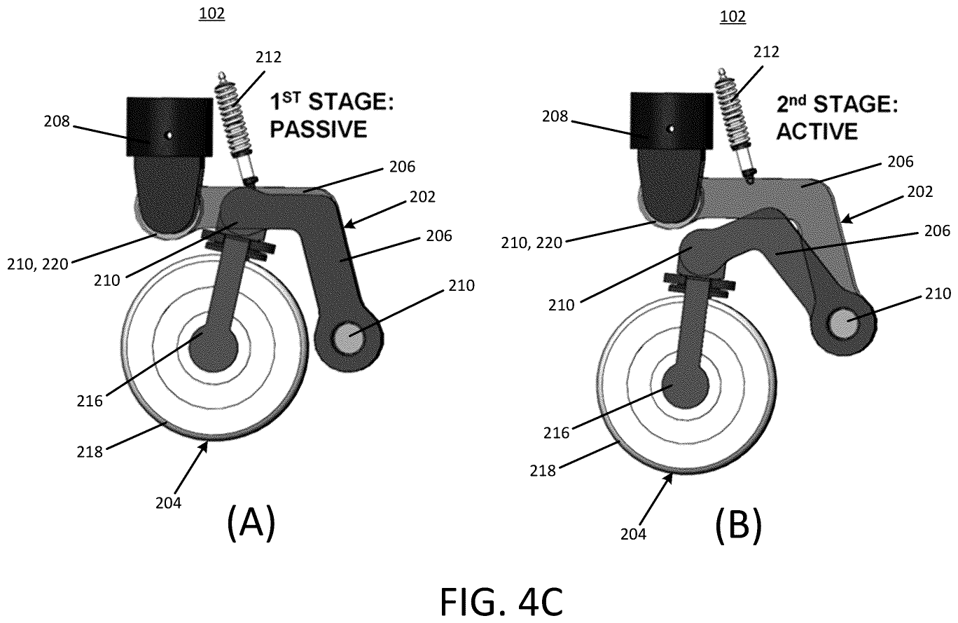

According to an exemplary embodiment, the UAV 130 may be configured to provide lift to an otherwise rolling and/or walking hybrid vehicle. Utilizing the one or more rotor systems 132 of the UAV 130 in synchronization with the wheeled and/or walking locomotion may provide a temporary performance and mobility advantage to a hybrid vehicle. For example, the one or more rotor systems 132 may be configured to lift a hybrid vehicle off the ground to enable relocation of the hybrid vehicle to a position beyond an obstacle. According to an exemplary embodiment, the one or more rotor systems 132 may be configured to be used in cooperation with a springing action of one or more leg components 202 (as shown, e.g., in FIGS. 4A-4C) of a hybrid vehicle to leap over an obstacle that could not ordinarily be traversed by the hybrid vehicle using just its leg components 202 and/or wheel components 204. For example, the one or more rotor systems 132 may not be capable of providing enough lift to maintain the hybrid vehicle in a stable aerial position in isolation, but may be configured to provide sufficient thrust to reduce the gravitational force on the hybrid vehicle body 114 and/or chassis 106 so that additional performance can be obtained over an absence of propulsion of the one or more rotor systems 132, thereby allowing for the traversal of otherwise non-traversable terrain. According to an exemplary embodiment, the one or more rotor systems 132 of the UAV 130 may be capable of providing enough lift to maintain the hybrid vehicle in a stable aerial position in isolation.

According to an exemplary embodiment, the one or more rotor systems 132 may be configured to be used to intentionally reduce a downforce on the hybrid vehicle so that the hybrid vehicle may scramble over a terrain with the driven wheels, reducing wear and tear, or provide a faster or less bumpy driving experience. In such exemplary embodiments, the one or more rotor systems 132 may improve hybrid vehicle performance in conjunction with wheeled locomotion, while also providing an improved driving experience for hybrid vehicles capable of transporting passengers.

According to an exemplary embodiment, the UAV 132 may be configured to provide additional support operations to the hybrid vehicle, such as, e.g., providing a charging station for the hybrid vehicle or other vehicles in the field, providing mapping and surveillance support, and/or transporting collected goods to or from the hybrid vehicle to a base station, among other support operations.

According to an exemplary embodiment, the UAV 130 may be an aircraft configured to perform autonomous and/or remotely controlled air travel. According to an exemplary embodiment, the UAV 130 may comprise one or more sensors 170. The one or more sensors 170 may comprise one or more cameras (e g., camera 140), one or more electronic devices capable of and configured to perform terrain surveillance and/or mapping, and/or one or more other suitable sensors. For example, a sensor 170 for mapping may comprise a digital camera, a 3-Dimensional (3D) camera, a sonar device, an ultrasound device, etc.

According to an exemplary embodiment, the UAV 130 may be electrically powered and/or may be configured to electrically couple with a hybrid vehicle. According to an exemplary embodiment, the UAV 130 may comprise a battery 180 configured to store power. According to an exemplary embodiment, the hybrid vehicle (e.g., hybrid vehicle 100 of FIG. 1 and hybrid vehicle 200 of FIG. 2) may be configured to charge the battery 180 of the UAV 130 (e.g., during land traversal and/or during other suitable events). It should be appreciated that the electrical connection for providing power may comprise a wired connection and/or a wireless connection

According to an exemplary embodiment, the UAV 300 may be configured to perform one or more remote operations, autonomous operations, and/or a combination of remote and autonomous operations. For example, a user may be able to remotely control one or more operations of the UAV 130, such as, e.g., from a command center. According to an exemplary embodiment, the UAV 130 may be configured to operate autonomously, such that a destination may be provided and the UAV 130 may be configured to self-navigate to the destination.

According to an exemplary embodiment, the UAV 130 may be an airborne propulsion system. According to an exemplary embodiment, the UAV 130 may be configured to propel itself and/or steer itself using any suitable means such as, e.g., one or more propellers, one or more wings, one or more rockets, one or more balloons, one or more rudders, and/or other suitable propulsion and/or steering mechanisms.

Referring now to FIGS. 4A and 4B, an example leg-wheel component 102 in a retracted position (FIG. 2A) and an extended position (FIG. 2B), are illustratively depicted, in accordance with an exemplary embodiment of the present disclosure.

Various embodiments of such leg-wheel components 102 are described, e.g., in co-pending U.S. patent application Ser. No. 16/743,310 (U S Patent Application Publication No. 2020/0216127). It is noted that other configurations of one or more leg-wheel components 102 may be incorporated into the present disclosure, while maintaining the spirit and functionality of the present disclosure

The leg-wheel component 102 may comprise a leg component 202 and a wheel component 204. The wheel component 204 may be coupled to the leg component 202

According to an exemplary embodiment, the leg-wheel component 102 may comprise a coupling component 208 configured to couple the leg-wheel component 102 to the body 114, chassis 106, frame, and/or other suitable component of a hybrid vehicle (e g., hybrid vehicle 100 of FIG. 1 and hybrid vehicle 200 of FIG. 2).

The leg component 202 may be divided into one or more segments 206. The one or more segments 206, coupling component 208, and/or the wheel component 204 may be configured to rotate about each other via one or more movable joint components 210. According to an exemplary embodiment, the leg-wheel component 102 may comprise one or more suspension systems 212 (e.g., springs, shock absorbers, etc.).

According to an exemplary embodiment, the wheel component 204 may be configured to rotate along an axis while coupled to the leg component 202, enabling the hybrid vehicle to move along a surface in contact with the wheel component 204. According to an exemplary embodiment, the leg-wheel component 102 may comprise one or more braking mechanisms for preventing and/or decreasing rotation of the wheel component 204.

With reference to FIG. 4A, the leg-wheel component 102 is in a retracted state, with the leg-wheel component 102 being configured and positioned to provide wheeled locomotion. With reference to FIG. 4B, the leg-wheel component 102 is in an extended state, with the leg-wheel component 102 being configured and positioned to provide walking locomotion.

According to an exemplary embodiment, wheeled locomotion may be available for use in situations where traditional vehicle travel using rolling wheels 204 is available (e.g., roads and highways). Wheeled locomotion is efficient, when available, for conveyance of a vehicle (e.g., hybrid vehicle 100 of FIG. 1 and hybrid vehicle 200 of FIG. 2) between destinations According to some exemplary embodiments, the leg-wheel components 102 may be configured to allow for active height adjustment of the hybrid vehicle, enabling the hybrid vehicle to go, e.g., from street use to off-road use.

In walking locomotion, the hybrid vehicle may be configured to walk up elevations and terrain that is not surmountable using wheeled locomotion. In some instances, walking locomotion allows for nimble and quiet motion, relative to wheeled locomotion. The hybrid vehicle may also be configured to move laterally, allowing for quadrupedal ambulation. According to an exemplary embodiment, the leg-wheel components 102 may be configured to provide a springing action and/or a jumping action to propel the hybrid vehicle away from a traversal surface

According to an exemplary embodiment, the leg-wheel components 102 may comprise one or more in-wheel motors 214 configured to power movement of the wheel component 204 and/or the leg component 202. The use of in-wheel motors 214 frees the suspension 212 from traditional axles and allows ambulation, but also increases the driving performance and adaptability.

By using the wheels 204 as feet, the electric motors 214 may be configured to lock for stable ambulation, but also have slow torque controlled rotation for micro movements when climbing or during self-recovery. According to some exemplary embodiments, the wheel 204 of the leg-wheel component 102 may be configured to rotate 180 degrees perpendicular to a hub 216, not only allowing leaning capability while driving, but also giving the wheels 204 enhanced positioning potential when a tire 218 is locked and in a walking mode. The wheel 204 may be configured to turn 90 degrees and even may be configured to be used as a wide foot pad, lowering the hybrid vehicle's pounds per square inch (PSI) footprint when walking over loose materials or fragile surfaces, similar to that of a snowshoe.

Referring now to FIG. 4C a diagram indicating a low range of motion suspension stage ((A), a passive stage), and a high range of motion suspension stage ((B), an active stage), of a leg-wheel component 102 is illustratively depicted, in accordance with an exemplary embodiment of the present disclosure.

According to an exemplary embodiment, the leg-wheel component 102 (also referred to herein as a “hybrid vehicle traversal component” (also referred to herein as a “leg-wheel component”) may be configured to provide two stage suspension a first, low range of motion suspension stage, when the leg-wheel component 102 is in a retracted position (A), and a second, high range of motion suspension stage, when the leg-wheel component 102 is in an extended position (B).

According to an exemplary embodiment, in the low range of motion suspension stage, a suspension system 212 (e.g., a coil-over suspension) is utilized and engaged when the leg-wheel component 102 is in a retracted position. According to an exemplary embodiment, while in the low range of motion suspension state, a knee joint component 220 of the leg-wheel component 102 may be relaxed, while the remaining joints 210 of the leg-wheel component 102 may be locked. During the low range of motion suspension stage, the leg-wheel component 102 may be configured to handle high-frequency vibrations through the chassis-mounted suspension system 212. According to an exemplary embodiment, when the leg-wheel component 102 is retracted and the low range of motion suspension stage is enabled, the hybrid vehicle (e.g., hybrid vehicle 100 of FIG. 1 and hybrid vehicle 200 of FIG. 2) may be configured to provide 0 to 5 inches of suspension during wheeled locomotion. It is noted, however, that other amounts of suspension may be incorporated while maintaining the spirit and functionality of the present disclosure.

According to an exemplary embodiment, in the high range of motion suspension stage, the suspension system 212 (e.g., the coil-over suspension) may be disengaged when the leg-wheel component 102 is in an extended or actuated position. For example, the suspension system 212 may be configured to remain with the chassis during the high range of motion suspension stage, and the knee joint 220 may be driven by a motor to provide suspension. According to an exemplary embodiment, during the high range of motion suspension stage, the leg-wheel component 102 may be configured to support advanced driving dynamics through the capabilities of a motor at the knee joint 220. According to an exemplary embodiment, when the leg-wheel component 102 is extended and the high range of motion suspension stage is enabled, the hybrid vehicle (e.g., hybrid vehicle 100 of FIG. 1 and hybrid vehicle 200 of FIG. 2) may be configured to provide 5 to 50 inches of suspension during walking locomotion. It is noted, however, that other amounts of suspension may be incorporated while maintaining the spirit and functionality of the present disclosure.

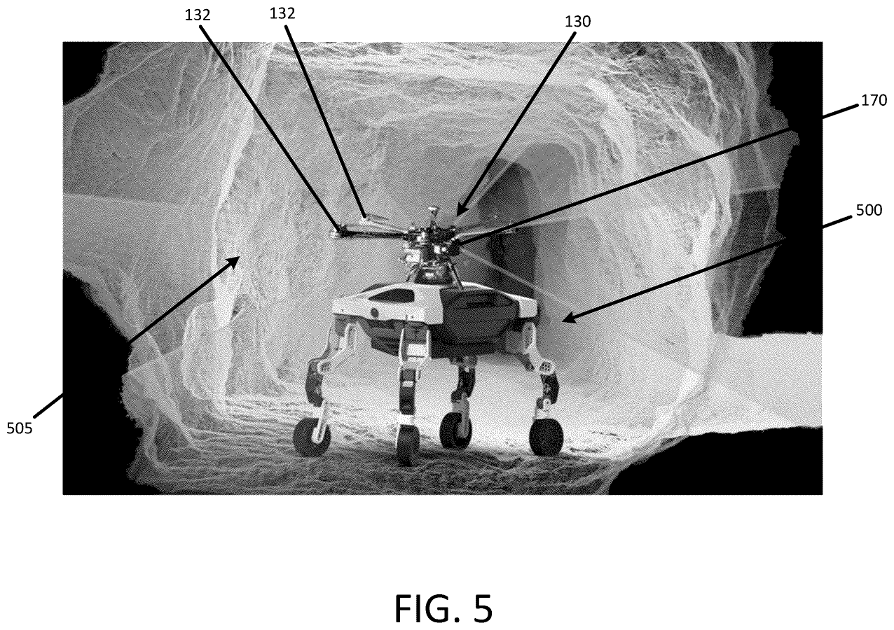

Referring now to FIG. 5, a hybrid vehicle 500 (e.g., hybrid vehicle 100 of FIG. 1 and hybrid vehicle 200 of FIG. 2) with an attached UAV 130 performing a mapping operation within a mine or cavern 505 is illustratively depicted, in accordance with an exemplary embodiment of the present disclosure.

According to an exemplary embodiment, while the hybrid vehicle 500 is navigating the mine or cavern 505, the UAV 130 may be configured to perform one or more mapping operations using one or more sensors 170 such as, e.g., an electronic device for mapping. According to an exemplary embodiment, should the hybrid vehicle 500 reach an obstacle that is not traversable using wheeled and/or walking locomotion, one or more rotor systems 132 of the UAV 130 may be configured to be used in synchronization with the wheeled and/or walking locomotion of the hybrid vehicle 500 to provide a temporary performance and mobility advantage to the hybrid vehicle 500 in overcoming the obstacle

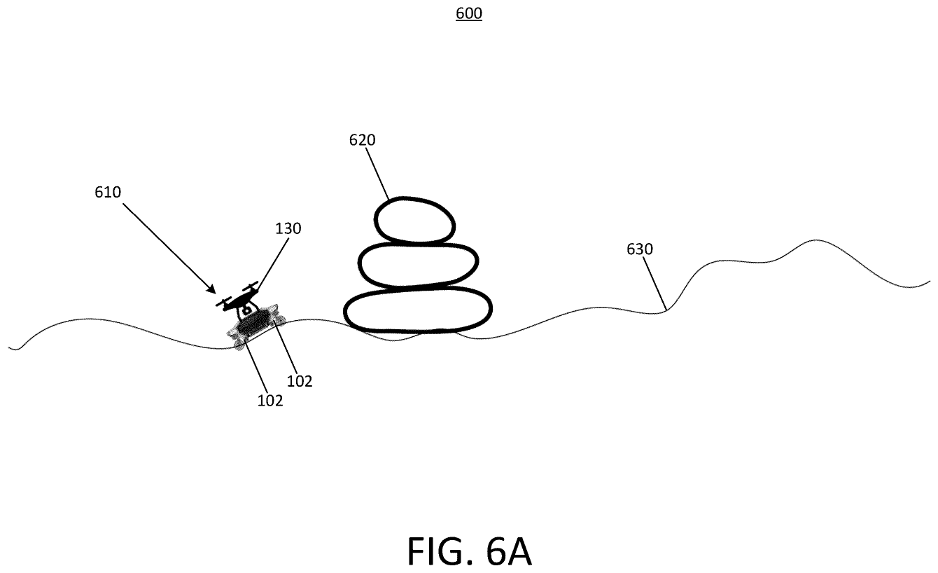

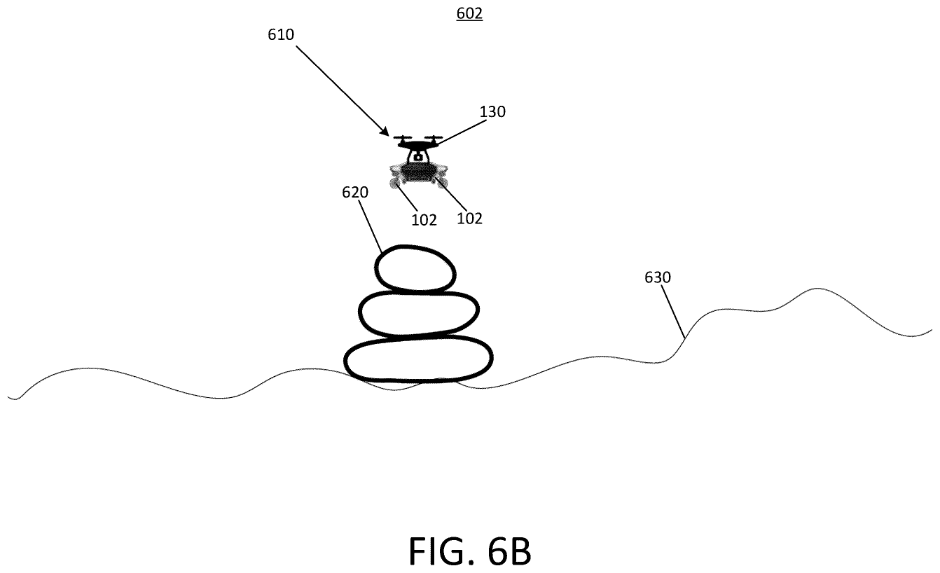

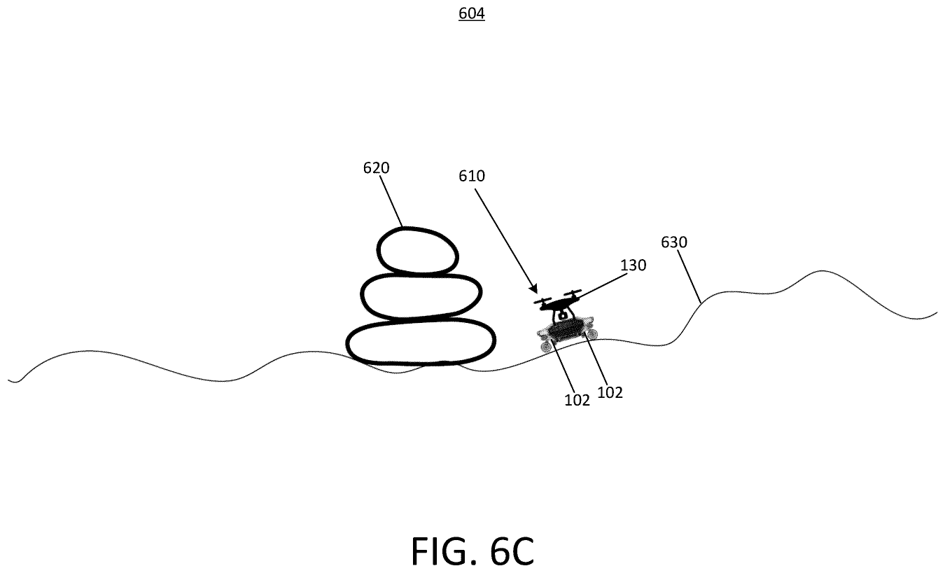

Referring now to FIGS. 6A through 6C, an example of a hybrid vehicle 610 (e.g., hybrid vehicle 100 of FIG. 1, hybrid vehicle 200 of FIG. 2, and hybrid vehicle 500 of FIG. S) comprising a rotor system navigating a terrain 630 using the propulsion of leg-wheel components 120 and the rotor system to overcome an obstacle 620 is illustratively depicted, in accordance with an exemplary embodiment of the present disclosure.

According to an exemplary embodiment, the rotor system may comprise an aerial drone and/or a UAV 130 comprising one or more rotor systems 132. It should be appreciated that the rotor system may be configured to be removably coupled to the hybrid vehicle 610. According to an exemplary embodiment, the rotor system may be a permanent fixture of the hybrid vehicle 610

Utilizing the rotor system in synchronization with the wheeled and/or walking locomotion of the hybrid vehicle 610 may provide a temporary performance and mobility advantage to the hybrid vehicle 610. For example, the rotor system may be configured to lift the hybrid vehicle 610 off the ground/terrain 630 to allow for relocation of the hybrid vehicle 610 to a position beyond an obstacle 620.

As shown in illustration 600 of FIG. 6A, at a first time, the hybrid vehicle 610 may encounter an obstacle 620 that is not traversable using a wheeled and/or walking mode of locomotion, and there is no way to circumvent or otherwise go around the obstacle 620. As shown in illustration 602 of FIG. 6B, at a second time, the hybrid vehicle 610 may utilize the rotor system (e.g., UAV 130) in synchronization with walking locomotion to jump or fly over the obstacle 620. The hybrid vehicle 610 may be configured to utilize the rotor system in cooperation with a springing action of leg components 202 of one or more of the leg-wheel components 102 to leap over the obstacle 620, where the obstacle 620 could not otherwise be traversed by the hybrid vehicle 610 using just its leg components 202 and/or wheel components 204. As shown in illustration 604 of FIG. 6C, at a third time, the hybrid vehicle 610 has overcome the obstacle 620 and continues on its way. According to an exemplary embodiment, when the hybrid vehicle 610 overcomes the obstacle 620, the hybrid vehicle 610 may disable the rotor system (e.g., UAV 130).

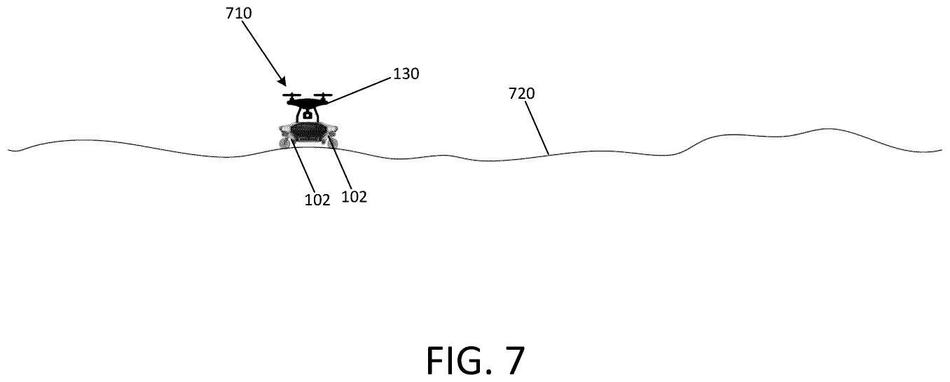

Referring now to FIG. 7, an example a hybrid vehicle 710 (e.g., hybrid vehicle 100 of FIG. 1, hybrid vehicle 200 of FIG. 2, hybrid vehicle 500 of FIG. 5, and hybrid vehicle 610 of FIGS. 6A-6C) comprising a coupled rotor system reducing a downforce using propulsion of the rotor system during navigation is illustratively depicted, in accordance with an exemplary embodiment of the present disclosure.

According to an exemplary embodiment, the rotor system may comprise a UAV 130 and/or an aerial drone. It should be appreciated that the rotor system may be configured to be removably coupled to the hybrid vehicle 710. According to an exemplary embodiment, the rotor system may be configured to be a permanent fixture of the hybrid vehicle 710. Utilizing the rotor system in synchronization with the wheeled and/or walking locomotion of the hybrid vehicle 710 may provide a temporary performance and mobility advantage to the hybrid vehicle 710.

According to an exemplary embodiment, and as shown in FIG. 7, a terrain 720 may be uneven but traversable using wheeled and/or walking locomotion. The rotor system may be configured to be used to intentionally reduce a downforce on the hybrid vehicle 710 so that the hybrid vehicle 710 may be configured to scramble over the terrain 720 with driven wheels 204 of the leg-wheel components 102, reducing wear and tear, or providing a faster or less bumpy driving experience. According to an exemplary embodiment, the rotor system (e.g., UAV 130) may improve the performance of the hybrid vehicle 710 in conjunction with the wheeled locomotion, while also providing an improved driving experience for a hybrid vehicles configured to transport passengers (e.g., hybrid vehicle 200 as shown in FIG. 2).

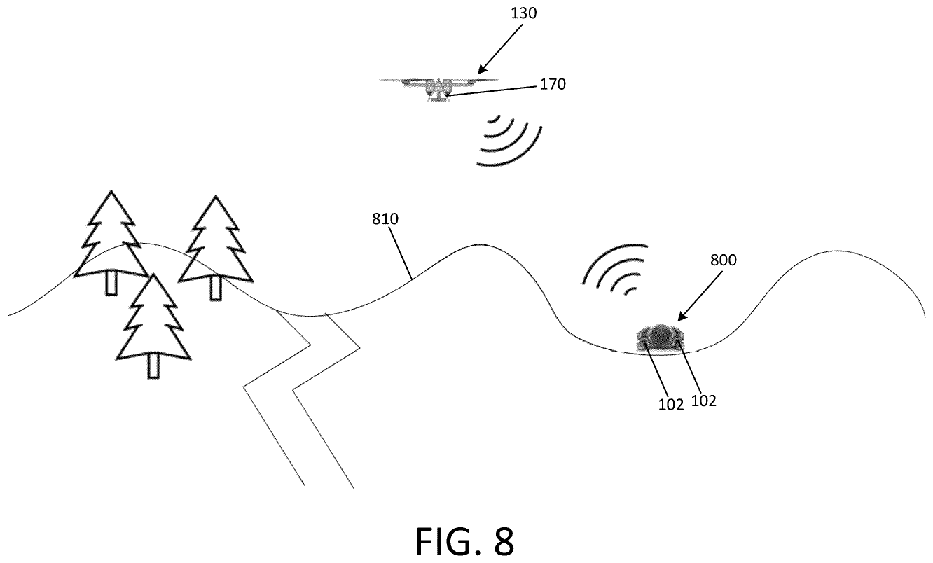

Referring now to FIG. 8, a diagram of a use case of a combination two vehicle system comprising a UAV 130 surveying a terrain 810 and communicating information about the terrain 810 to a hybrid vehicle 800 (e.g., hybrid vehicle 100 of FIG. 1, hybrid vehicle 200 of FIG. 2, hybrid vehicle 500 of FIG. 5, hybrid vehicle 610 of FIGS. 6A-6C, and hybrid vehicle 710 of FIG. 7) is illustratively depicted, in accordance with an exemplary embodiment.

According to an exemplary embodiment, the hybrid vehicle 800 may be configured to perform one or more ground operations under, e g., autonomous and/or remote control, and may have incomplete information as to the terrain 810 that must be traveled over. Conditions on the ground may not be known due to changes to, e.g., the environment (e.g., natural disasters) and/or weather (e.g., flooding), among other suitable causes.

In such use cases, the UAV 130 may be configured to scan (using, e.g., one or more sensors 170) the terrain 810 and perform mapping of areas of interest (e.g., areas of travel by the hybrid vehicle 800). The UAV 130 may be configured to transmit the information about the terrain 810, such as, e.g., mapping information, to the hybrid vehicle 800. The hybrid vehicle 800 may be configured to then use this information, in addition to any information it has or is capable of obtaining on its own, to supplement the navigation of the hybrid vehicle 800 over the terrain 810 This symbiotic use case of the UAV 130 supplementing the navigation information of the hybrid vehicle 800 is particularly useful in extreme environments where the terrain 810 may be unknown. For example, this may be particularly useful in the exploration of the moon or other planets.

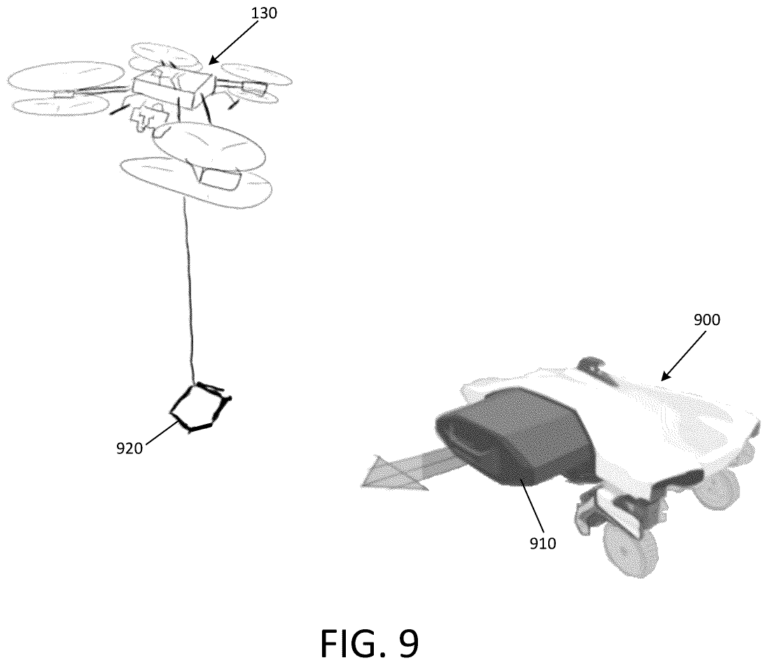

Referring now to FIG. 9, a diagram of a use case of a combination two vehicle system comprising a hybrid vehicle 900 (e g., hybrid vehicle 100 of FIG. 1, hybrid vehicle 200 of FIG. 2, hybrid vehicle 500 of FIG. 5, hybrid vehicle 610 of FIGS. 6A-6C, hybrid vehicle 710 of FIG. 7, and hybrid vehicle 800 of FIG. 8) comprising a cargo pod 910 and a UAV 130 for transporting the cargo pod 910, in accordance with an exemplary embodiment.

According to an exemplary embodiment, certain ground-based operations in which the hybrid vehicle 900 may be used may be for the collection of goods and/or materials. Goods and/or materials may be loaded into the cargo pod 910, which may be removable from the hybrid vehicle 900 and/or permanently fixed to the hybrid vehicle 900. The hybrid vehicle 900 may be configured to transport the cargo pod 910, including the goods and/or materials.

According to an exemplary embodiment, the UAV 130 may be configured to retrieve the cargo pod 910 (e.g., using a connection mechanism 920) including the collected goods and/or materials, and/or may be configured to deliver the cargo pod 910 to another destination while the hybrid vehicle 900 continues collection According to an exemplary embodiment, the hybrid vehicle 900 may comprise more than one cargo pod 910 and/or UAV 130. According to an exemplary embodiment, the UAV 130 may be configured to deliver a cargo pod 910 to the hybrid vehicle 900 and retrieve another cargo pod 910 from the hybrid vehicle 900, such that the ground operation may continue while the UAV 130 transports the first cargo pod 910 to another destination.

According to some exemplary embodiments, the hybrid vehicle with an aerial drone described herein (e g., hybrid vehicle 100 of FIG. 1, hybrid vehicle 200 of FIG. 2, hybrid vehicle 500 of FIG. 5, hybrid vehicle 610 of FIGS. 6A-6C, hybrid vehicle 710 of FIG. 7, hybrid vehicle 800 of FIG. 8, and hybrid vehicle 900 of FIG. 9) may be configured to be used in search and rescue operations Mine caves-ins are an unfortunate side effect of underground mining operations. The aerial drone described herein, operating in conjunction with the walking vehicle, may be configured to reach locations that might not otherwise be accessible by walking vehicle or humans. According to some exemplary embodiments, the aerial drone may be configured to deliver goods (e.g., food, water, oxygen, etc.) to a site of a cave-in, if there is an opening, to any persons in the cave that need assisting in the rescue efforts.

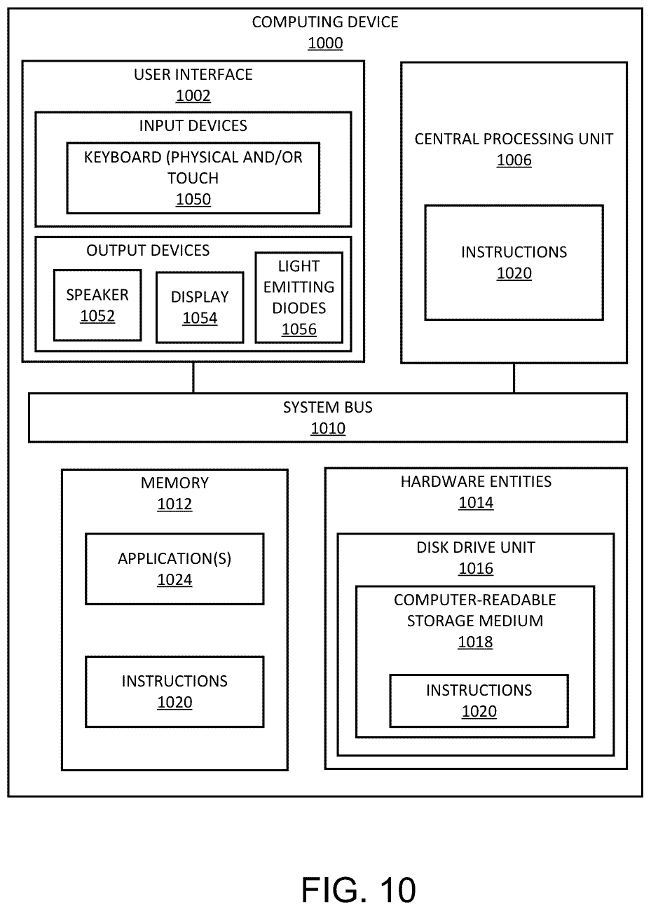

Referring now to FIG. 10, an illustration of an example architecture for a computing device 1000 is provided. According to an exemplary embodiment, one or more functions of the present disclosure may be implemented by a computing device such as, e.g., computing device 1000 or a computing device similar to computing device 1000

The hardware architecture of FIG. 10 represents one example implementation of a representative computing device configured to perform one or more methods and means for controlling a vehicle capable of locomotion using both walking motion and rolling traction, as described herein As such, the computing device 1000 of FIG. 10 implements at least a portion of the method(s) described herein and/or implements at least a portion of the functions of the hybrid vehicle(s) described herein (e.g., hybrid vehicle 100 of FIG. 1, hybrid vehicle 200 of FIG. 2, hybrid vehicle 500 of FIG. 5, hybrid vehicle 610 of FIGS. 6A-6C, hybrid vehicle 710 of FIG. 7, hybrid vehicle 800 of FIG. 8, and hybrid vehicle 900 of FIG. 9)

Some or all components of the computing device 1000 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 10, the computing device 1000 may comprise a user interface 1002, a Central Processing Unit (“CPU”) 1006, a system bus 1010, a memory 1012 connected to and accessible by other portions of computing device 1000 through system bus 1010, and hardware entities 1014 connected to system bus 1010. The user interface may comprise input devices and output devices, which may be configured to facilitate user-software interactions for controlling operations of the computing device 1000. The input devices may comprise, but are not limited to, a physical and/or touch keyboard 1040. The input devices may be connected to the computing device 1000 via a wired or wireless connection (e.g., a Bluetooth® connection). The output devices may comprise, but are not limited to, a speaker 1042, a display 1044, and/or light emitting diodes 1046.

At least some of the hardware entities 1014 may be configured to perform actions involving access to and use of memory 1012, which may be a Random Access Memory (RAM), a disk driver and/or a Compact Disc Read Only Memory (CD-ROM), among other suitable memory types. Hardware entities 1014 may comprise a disk drive unit 1016 comprising a computer-readable storage medium 1018 on which may be stored one or more sets of instructions 1020 (e.g., programming instructions such as, but not limited to, software code) configured to implement one or more of the methodologies, procedures, or functions described herein. The instructions 1020 may also reside, completely or at least partially, within the memory 1012 and/or within the CPU 1006 during execution thereof by the computing device 1000.

The memory 1012 and the CPU 1006 may also constitute machine-readable media. The term “machine-readable media”, as used here, refers to a single medium or multiple media (e.g., a centralized or distributed database, and/or associated caches and servers) that store the one or more sets of instructions 1020. The term “machine-readable media”, as used here, also refers to any medium that is capable of storing, encoding or carrying a set of instructions 1020 for execution by the computing device 1000 and that cause the computing device 1000 to perform any one or more of the methodologies of the present disclosure.

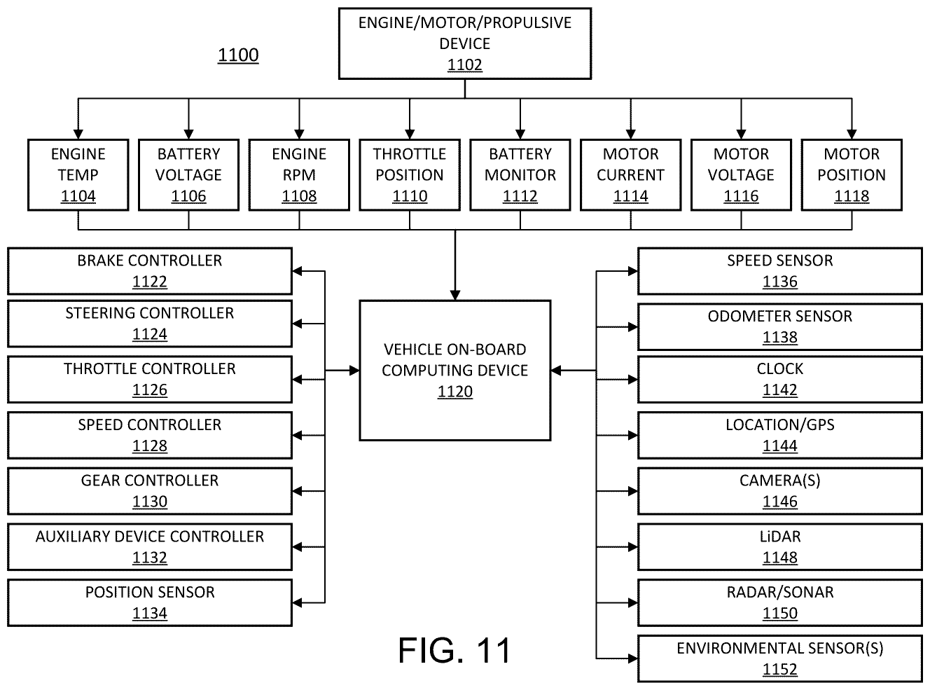

Referring now to FIG. 11, an example vehicle system architecture 1100 for a vehicle is provided, in accordance with an exemplary embodiment of the present disclosure

Hybrid vehicles 100, 200, 500, 610, 710, 800, and 900 may have the same or similar system architecture as that shown in FIG. 11. Thus, the following discussion of vehicle system architecture 1100 is sufficient for understanding one or more components of hybrid vehicles 100, 200, 500, 610, 710, 800, and 900.

As shown in FIG. 11, the vehicle system architecture 1100 may comprise an engine, motor or propulsive device (e.g., a thruster) 1102 and various sensors 1104-1118 for measuring various parameters of the vehicle system architecture 1100 In gas-powered or hybrid vehicles having a fuel-powered engine, the sensors 1104-1118 may comprise, for example, an engine temperature sensor 1104, a battery voltage sensor 1106, an engine Rotations Per Minute (RPM) sensor 1108, and/or a throttle position sensor 1110. If the vehicle is an electric or hybrid vehicle, then the vehicle may comprise an electric motor, and accordingly may comprise sensors such as a battery monitoring system 1112 (to measure current, voltage and/or temperature of the battery), motor current 1114 and voltage 1116 sensors, and motor position sensors such as resolvers and encoders 1118.

Operational parameter sensors that are common to both types of vehicles may comprise, for example: a position sensor 1134 such as an accelerometer, gyroscope and/or inertial measurement unit; a speed sensor 1136; and/or an odometer sensor 1138. The vehicle system architecture 1100 also may comprise a clock 1142 that the system uses to determine vehicle time and/or date during operation. The clock 1142 may be encoded into the vehicle on-board computing device 1120, it may be a separate device, or multiple clocks may be available.

The vehicle system architecture 1100 also may comprise various sensors that operate to gather information about the environment in which the vehicle is traveling. These sensors may comprise, for example, a location sensor 1144 (for example, a Global Positioning System (GPS) device); object detection sensors such as one or more cameras 1146; a LIDAR sensor system 1148; and/or a RADAR and/or a sonar system 1150. The sensors also may comprise environmental sensors 1152 such as, e.g., a humidity sensor, a precipitation sensor, a light sensor, and/or ambient temperature sensor. The object detection sensors may be configured to enable the vehicle system architecture 1100 to detect objects that are within a given distance range of the vehicle in any direction, while the environmental sensors 1152 may be configured to collect data about environmental conditions within the vehicle's area of travel.

During operations, information may be communicated from the sensors to an on-board computing device 1120 (e.g., computing device 1000 of FIG. 10). The on-board computing device 1120 may be configured to analyze the data captured by the sensors and/or data received from data providers and may be configured to optionally control operations of the vehicle system architecture 1100 based on results of the analysis. For example, the on-board computing device 1120 may be configured to control, braking via a brake controller 1122; direction via a steering controller 1124; speed and acceleration via a throttle controller 1126 (in a gas-powered vehicle) or a motor speed controller 1128 (such as a current level controller in an electric vehicle); a differential gear controller 1130 (in vehicles with transmissions); and/or other controllers. The brake controller 1122 may comprise a pedal effort sensor, pedal effort sensor, and/or simulator temperature sensor, as described herein.

Geographic location information may be communicated from the location sensor 1144 to the on-board computing device 1120, which may then access a map of the environment that corresponds to the location information to determine known fixed features of the environment such as streets, buildings, stop signs and/or stop/go signals. Captured images from the cameras 1146 and/or object detection information captured from sensors such as LIDAR 1148 may be communicated from those sensors to the on-board computing device 1120 The object detection information and/or captured images may be processed by the on-board computing device 1120 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A hybrid vehicle, comprising:
a chassis;
a plurality of leg-wheel components coupled to the chassis, wherein the plurality of leg-wheel components are configured to be collectively operable to provide wheeled locomotion and walking locomotion;
an airborne propulsion system, coupled to the chassis; and
a processor configured to cause the plurality of leg-wheel components and the airborne propulsion system to propel a hybrid vehicle,
wherein the airborne propulsion system is configured to operate synchronously with at least one of the wheeled locomotion and walking locomotion.

2. The hybrid vehicle of claim 1, wherein the processor is further configured to automatically propel the hybrid vehicle along a path using one or more of:
one or more of the plurality of leg-wheel components; and
the airborne propulsion system.

3. The hybrid vehicle of claim 2, further comprising one or more sensors configured to detect one or more obstacles within the path of the hybrid vehicle,
wherein the processor is further configured to:
determine whether the one or more obstacles are traversable using walking or wheeled locomotion, and
when the one or more obstacles are not traversable using walking or wheeled locomotion, cause the airborne propulsion system to propel the hybrid vehicle to overcome the one or more obstacles.

4. The hybrid vehicle of claim 1, wherein the airborne propulsion system is permanently affixed to the chassis.

5. The hybrid vehicle of claim 1, wherein the airborne propulsion system is detachably coupled to the chassis.

6. The hybrid vehicle of claim 5, wherein the airborne propulsion system comprises an unmanned aerial vehicle (UAV).

7. The hybrid vehicle of claim 1, wherein the airborne propulsion system comprises at least one rotor system.

8. The hybrid vehicle of claim 1, wherein the airborne propulsion system is configured to reduce a downforce on the hybrid vehicle for synchronous operation during wheeled locomotion.

9. The hybrid vehicle of claim 1, wherein the airborne propulsion system is configured to perform synchronous operation during a springing action of one or more of the plurality of leg-wheel components during the walking locomotion.

10. The hybrid vehicle of claim 1, further comprising one or more sensors configured to perform one or more of:
terrain surveillance; and
terrain mapping.

11. The hybrid vehicle of claim 10, wherein the one or more sensors comprises one or more cameras.

12. The hybrid vehicle of claim 10, wherein at least one of the one or more sensors are coupled to the airborne propulsion system.

13. A system for controlling a hybrid vehicle, comprising:
a hybrid vehicle, comprising:
a chassis;
a plurality of leg-wheel components coupled to the chassis, wherein the plurality of leg-wheel components are configured to be collectively operable to provide wheeled locomotion and walking locomotion; and
an airborne propulsion system, coupled to the chassis; and
a computing device, comprising a processor and a memory, configured to store programming instructions that, when executed by the processor, cause the processor to:
cause the airborne propulsion system to operate synchronously with at least one of the wheeled locomotion and walking locomotion.

14. The system of claim 13, wherein the airborne propulsion system is detachably coupled to the chassis.

15. The system of claim 14, wherein the airborne propulsion system comprises an unmanned aerial vehicle (UAV).

16. The system of claim 13, wherein:
the airborne propulsion system is configured to reduce a downforce on the hybrid vehicle for synchronous operation during wheeled locomotion, and
the programming instructions, when executed by the processor, cause the processor to:
cause the airborne propulsion system to reduce the downforce on the hybrid vehicle for synchronous operation during wheeled locomotion.

17. The system of claim 13, wherein:
the airborne propulsion system is configured to perform synchronous operation during a springing action of one or more of the plurality of leg-wheel components during the walking locomotion, and
the programming instructions, when executed by the processor, cause the processor to:
cause the airborne propulsion system to perform synchronous operation during the springing action of the one or more of the plurality of leg-wheel components during the walking locomotion.

18. The hybrid vehicle of claim 13, further comprising one or more sensors configured to perform one or more of:
terrain surveillance; and
terrain mapping.

19. The system of claim 18, wherein the one or more sensors comprises one or more cameras.

20. The system of claim 18, wherein at least one of the one or more sensors are coupled to the airborne propulsion system.
